(19) United States
(12) Patent Application Publication
(10) Pub. No.: US 2007/0174177 A1
(43) Pub. Date: Jul. 26, 2007

(54) SYSTEM AND METHOD FOR TRADING A FINANCIAL INVESTMENT INSTRUMENT

(76) Inventor: Todd A. Repass, Toledo, OH (US)

Correspondence Address: ADVANTIA LAW GROUP, 9035 SOUTH 1300 EAST, SUITE 200, SANDY, UT, 84094, US

(21) Appl. No.: 11/618,536

(22) Filed: Dec. 29, 2006

Related U.S. Application Data
(60) Provisional application No. 60/755,496, filed on Dec. 30, 2005.

(51) Int. Cl. G06Q 40/00

(52) U.S. Cl. 705/37

(57) ABSTRACT

A method of purchasing a financial instrument. Steps include: selecting a financial instrument; observing a buy signal on a slow stochastics oscillator, wherein the buy signal is a crossover of a fast line crossing up through a slow line; observing a confirming buy signal on a Williams % R oscillator, wherein the confirming indicator is a Williams % R line crossing up through a threshold of −25 on a Williams % R oscillator chart; observing a confirming volume statistic of greater than 199,999 volume; observing a confirming relative buying statistic of greater than 39 institutional activity; and purchasing the financial instrument, wherein the purchasing step is contingent on all of the observations and wherein the purchase includes a trailing stop-loss order.

### CROSS-REFERENCE TO RELATED APPLICATIONS

This invention claims priority, under 35 U.S.C. § 120, to the U.S. Provisional Patent Application No. 60/755,496 to Todd A. Repass filed on Dec. 30, 2005, which is incorporated by reference herein.

### BACKGROUND OF THE INVENTION

1. Field of the Invention

The present invention relates to business systems and methods of trading, specifically a system and method for trading a financial investment instrument.

2. Description of the Related Art

Generally, markets have become a platform to exchange goods and services for a certain price. For example, prices of stocks in the stock market fluctuate as the supply and demand change. Investors/purchasers have been known to engage in investment strategies to attempt to predict changes in the stock market. Investment strategies have been employed to implement certain actions in order to attempt to predict future stock market levels. Investment strategy is an important part in determining the risks and rewards in the stock market.

Since the opening of the stock market, purchasers have been applying various factors into selected strategies to provide a higher return on their investments. In the past, market information has been limited and not readily available to all purchasers. Recent advances in technology have further increased the ability of the public to participate in markets.

Accordingly, purchasers have been attempting to use this information to reduce risk and increase the likelihood of financial gain. Several methods, systems, and devices have been developed to signal to a user to buy and/or sell a stock for the purpose of profit. These methods have been developed to increase market profitability by evaluating the exchange between goods and services; and the price paid for those goods and services. Some improvements have been made in the field. Examples include but are not limited to the references described below, which references are incorporated by reference herein:

U.S. Pat. No. 5,761,442, issued to Barr et al., discloses a data processing system and method for selecting securities and constructing an investment portfolio is based on a set of artificial neural networks which are designed to model and track the performance of each security in a given capital market and output a parameter which is related to the expected risk adjusted return for the security. Each artificial neural network is trained using a number of fundamental and price and volume history input parameters about the security and the underlying index. The system combines the expected return/appreciation potential data for each security via an optimization process to construct an investment portfolio which satisfies predetermined aggregate statistics. The data processing system receives input from the capital market and periodically evaluates the performance of the investment portfolio, rebalancing it whenever necessary to correct performance degradations.

U.S. Pat. No. 5,978,778, issued to O'Shaughnessy, disclose an invention in the field of using a computer to select corporate stocks for investment. Fifty stocks are selected from a database on the basis of certain criteria. The stocks are acquired in equal proportions, and the portfolio is rebalanced at the end of an annual term. A method of the present invention uses either a growth strategy, a value strategy, or both strategies. Growth Model 3 strategy selects the stocks with the best 1-year price performance from All Stocks (stocks with market capitalization more than $150 million) with earnings gains for five consecutive years that also have price-to-sales ratios below 1.5. Value Model 3 strategy selects market leading stocks with the highest dividend yields (excluding utilities so they do not dominate the list). Market leading stocks come from the Large Stocks Universe and have: more common shares outstanding than the average stock in the database, cash flows per share exceeding the database mean, and corporate sales that are 1.5 times the database mean. A stock portfolio may be constructed which uses both Growth Model 3 and Value Model 3 in chosen proportion to one another. At the end of an annual term, the amount of money generated by the two strategies is pooled and then re-invested in accordance with the chosen proportion (which may change over time).

U.S. Patent Application Publication No.: 2005/0278237, by Dankovchik et al., discloses an invention that provides a system, apparatus and method for performing a multiple condition investment transaction by: (a) receiving a transaction request for an investment containing two or more non-time-based conditions, each non-time-based condition having an action to be performed whenever the non-time-based condition is satisfied, (b) obtaining market information for the investment, (c) determining whether any of the two or more non-time-based conditions are satisfied based on the market information, (d) repeating steps (b) through (e) whenever none of the two or more non-time-based conditions are satisfied, and (e) performing the action associated with each non-time-based condition that is satisfied whenever any of the non-time-based conditions are satisfied.

U.S. Patent Application Publication No.:2002/0099636, by Narumo, discloses an invention in the field of using a computer implemented method to calculate and provide recommendations for stock share investment timing. The process gathers price and volume data of listed firms from as many stock markets as implemented; only conditions being that those markets price data are available over the Internet, in order to be able to automate the process. Analyzing and calculation methods used within the process differ from those used in typical technical stock analyses in that the invention takes advantage of the known price history and uses statistical mathematics to categorize the current price to a recommended action: ‘sell’, ‘buy’ or ‘hold’, while the most famous technical analyzing methods typically try to predict the share price in the near future.

The inventions heretofore known suffer from a number of disadvantages which include being complex, unreliable, unpredictable, limited in applicability, and inefficient.
Accordingly, there exists a need for a method, device, and/or system for qualifying a stock that solves one or more of the problems herein described or that may come to the attention of one skilled in the art after becoming familiar with this specification.

### SUMMARY OF THE INVENTION

The present invention has been developed in response to the present state of the art, and in particular, in response to the problems and needs in the art that have not yet been fully solved by currently available business systems and methods of trading. Accordingly, the present invention has been developed to provide a system and method for trading a financial investment instrument.

In one embodiment, there is a method of purchasing a financial instrument including one or more of the following steps: selecting a financial instrument; observing a buy signal on an oscillator that may be a slow stochastics oscillator, and wherein the buy signal may be a crossover of a fast line crossing up through a slow line; observing a confirming buy signal on a second oscillator that may be a Williams % R oscillator, wherein the confirming indicator may be a Williams % R line crossing up through a threshold that may be a −25 mark on a Williams % R oscillator chart; observing a confirming volume statistic that may be greater than 199,999 volume; observing a confirming relative buying statistic that may be greater than 39 institutional activity; and purchasing the financial instrument, wherein the purchasing step may be contingent on one, more, or all of the observations and wherein the purchase may include a stop-loss order that may be a trailing stop-loss order.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 illustrates a. method for trading a financial instrument according to one embodiment of the invention;

FIG. 2 illustrates an oscillator and buy signal according to one embodiment of the invention;

FIG. 3 illustrates an oscillator and confirming signal according to one embodiment of the invention;

FIG. 4 illustrates a volume statistic according to one embodiment of the invention;

FIG. 5 illustrates a relative buying activity statistic according to one embodiment of the invention; and

FIG. 6 illustrates a price chart according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

As used herein:

“Buy signal” is an indication to purchase, based on a pre-arranged rule, occurring as an objectively observed action on a chart. For example, movement of price beyond an enumerated threshold or a beyond a fixed line;

“Oscillator” is a charting study that is constrained between two extreme values and built with the results from a trend indicator for discovering short-term overbought or oversold conditions. The overbought and oversold extremes are typically identified by horizontal lines in the top and bottom area of the oscillator's chart, which delineate the extremes as a separate area from the larger, middle body of the study. Stochastics and Williams % R are two examples of oscillators. Other common oscillators are: MACD (Moving Average Convergence Divergence), RSI (Relative Strength Index) and CCI (Commodity Channel Index). All of these oscillators are generally correlated one to another, but are calculated differently. Each has an overbought and oversold extreme but generally defined at different points;

“Volume” is a metric which measures buying and selling activity or the financial instrument, usually the number of units bought and sold for a given time period. Volume helps determine sentiment and breadth of the instrument's move; and

“Financial Instrument” is a stock, bond, derivative, future, currency pair or other security traded on a market.

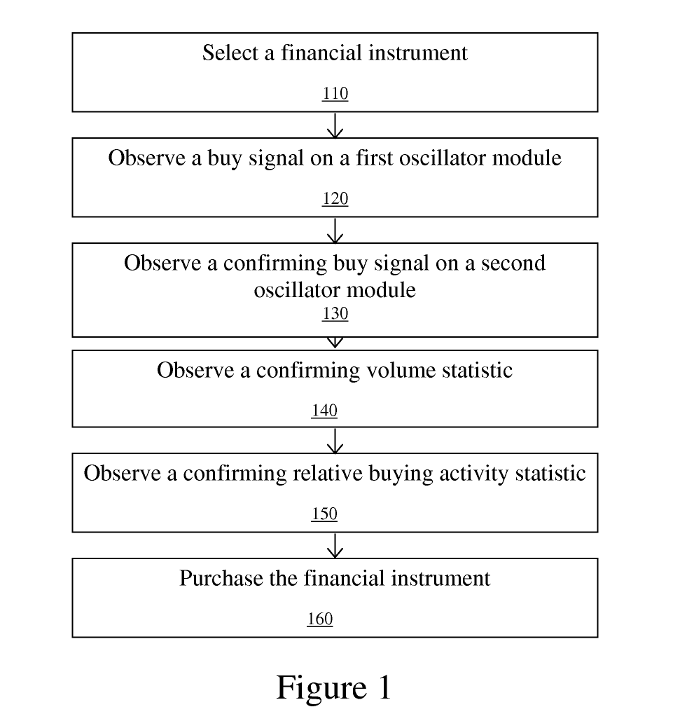

FIG. 1 illustrates a. method for trading a financial instrument according to one embodiment of the invention. In particular, there following steps are illustrated: selecting 110 a financial instrument for review; observing 120 a buy signal on a first oscillator module; observing 130 a confirming buy signal on a second oscillator module; observing 140 a confirming volume statistic; observing 150 a confirming relative buying activity statistic; and purchasing 160 the financial instrument. Advantageously, these steps enable a purchaser of financial instruments to decrease risk in trading.

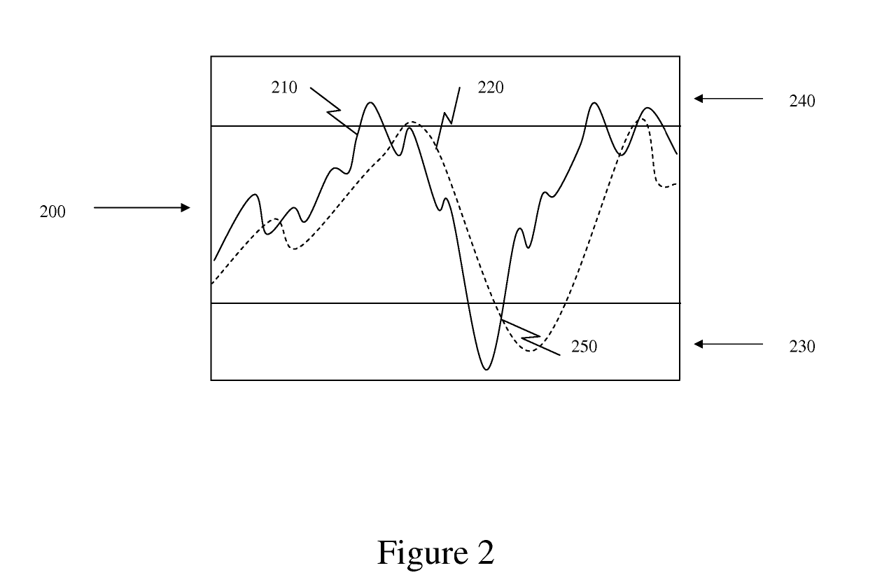

In selecting 110 a financial instrument for review, a purchaser is generally free to choose any publicly traded financial instrument upon which statistical data is available. Sources of such data include but are not limited to: proprietary trading platforms and service providers such as but not limited to Professor Trades Market Platform Professional Trading Software by Professor Trades at 6725 West Central Avenue Suite M328, Toledo, Ohio 43617 (www.professortrades.com). Non-limiting examples of details in these steps are further described in FIGS. 2-5.

In particular, FIG. 2 illustrates an oscillator and buy signal according to one embodiment of the invention. Illustrated is an oscillator 200 displaying information regarding a particular financial instrument. The oscillator 200 includes a first curve 210 and a second curve 220. Further, there is a lower region 230 and an upper region 240. There is also shown a buy signal 250, wherein the first curve 210 crosses the second curve 220 in the lower region 230. This buy signal 250 is an objective indicia having a binary status. In other words, the buy signal 250 is either present or not. The buy signal 250 is not present to a certain degree. Accordingly, an observer is able to determine whether the buy signal is present or not without resorting to subjective judgment based on experience. Advantageously, the buy signal 250 is a tool that may be used by those who are less experienced than professional traders.

In one non-limiting example, the oscillator 200 is a slow stochastics oscillator. Accordingly, the first curve 210 is a Fast % K and the second curve 220 is a Slow % D. When the Fast Curve 210 crosses upward through the Slow Curve 220 there is a buy signal 250. When a buy signal 250 is observed, further steps are taken to confirm the buy signal 250 thereby increasing the likelihood that the price of the financial instrument will experience a substantial increase in price, thereby providing wealth to the purchaser. Other buy signals are contemplated, such as when using other oscillators.

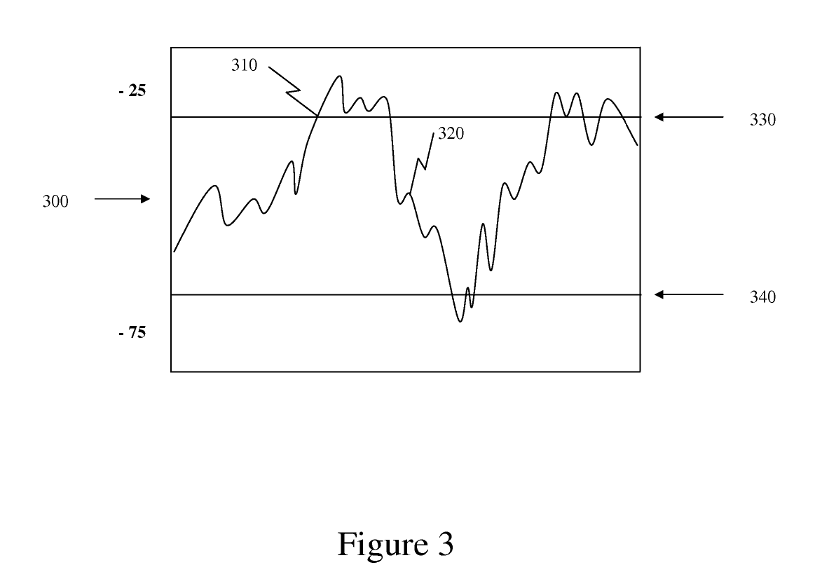

FIG. 3 illustrates an oscillator and confirming signal according to one embodiment of the invention. There is shown a second oscillator 300 including a curve 320. There is also shown a first threshold line 330 and a second threshold line 340. The first threshold line 330 defines an upper region labeled as “−25.” The second threshold line 340 defines a lower region labeled as “−75.” It is contemplated that there may be more or less threshold lines and that threshold lines may be disposed at different locations. Further, there is shown a confirming buy signal 310 where the curve 320 crosses up through the first threshold line 330 into the region labeled “−25.” Wherein a buy signal has been observed in a first oscillator 200, a user watches a second oscillator for a confirming buy signal 310.

In one non-limiting example, the second oscillator is a Williams % R chart showing information relating to a predetermined financial instrument. The “−25” region is identified, in this example by a threshold line 330. When the curve 320 crosses up through the threshold line 330 and into the “−25” region, such is a confirming buy signal. When the confirming buy signal follows a buy signal from another oscillator, a user proceeds through the process in determining whether to purchase a particular financial instrument.

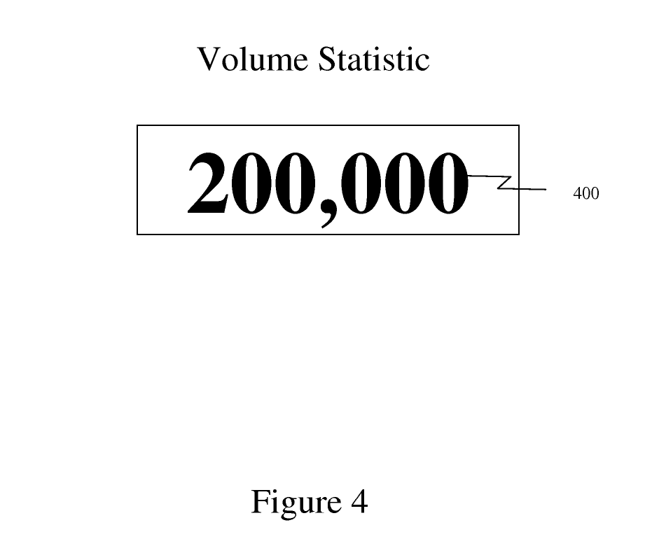

FIG. 4 illustrates a volume statistic according to one embodiment of the invention. There is shown a volume statistic 400 of “200,000.” In the illustrated example, the volume statistic is a raw number showing daily trading volume. In one embodiment, a raw daily volume of 200,000 or more is a confirming volume statistic. Further, in one embodiment, wherein a buy signal and confirming buy signal are observed, a user researches a volume statistic for a confirming volume statistic. Where such is observed, the user/purchaser proceeds through the method.

It is envisioned that a volume statistic may be embodied in a plethora of ways. There may be one or more charts showing volume over time, there may be a volume indicator having a binary display indicating when the volume statistic is over a threshold or not. In one embodiment, volume data may be processed and/or conditioned according to one or more formulae and/or may include one or more other data sets of market information.

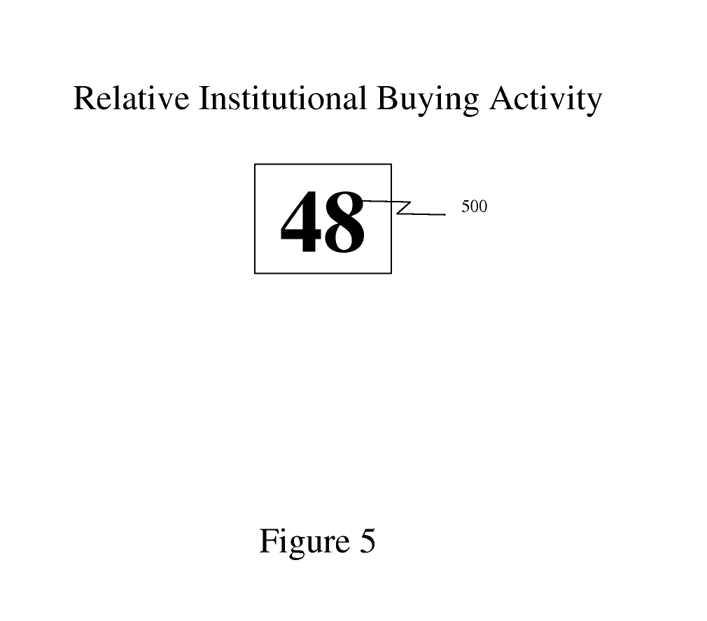

FIG. 5 illustrates a relative buying activity statistic according to one embodiment of the invention. There is shown a raw number 500 “48” indicating relative institutional buying activity. Relative buying activity is generally calculated as a ranking among a plurality of market sectors/industries/stocks/etc. for buying activity/volume. Accordingly, a relative buying activity statistic provides information regarding interest in a particular financial instrument as compared to one or more others. As with the volume statistic, the relative buying activity statistic may be processed and/or conditioned and/or may be displayed in a mode other than a raw number.

In the illustrated example, the raw number represents Institutional Buying Activity, such that when the number is above 40, there is a reasonable likelihood that institutional buyers are participating or are likely to be participating in the near future in buying activity for the financial instrument. Accordingly, a confirming statistic in this example includes wherein the Institutional Buying Activity is 40 or greater.

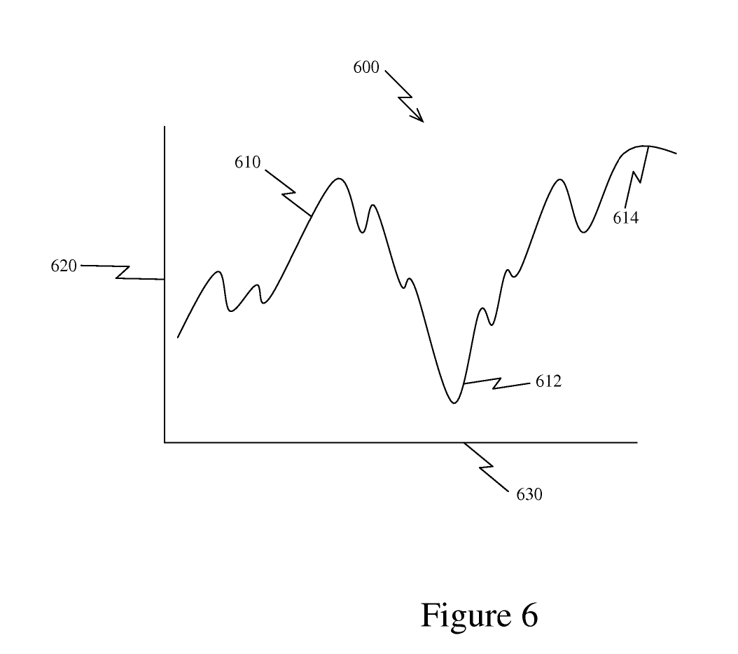

FIG. 6 illustrates a price chart according to one embodiment of the invention. In particular, there is shown a line/curve 610 representing a particular financial instrument displayed on a price axis 620 and a time axis 630. Further shown is an entry point 612 wherein a purchaser may purchase the financial instrument. More, there is an exit point 614 representing a potential selling point wherein the purchaser may sell the financial instrument for gain. In one embodiment, the purchaser uses one or more of the method steps described herein to determine a purchase which may fall on the purchase point 612. Further, the purchase may be made with a stop-loss order. The stop-loss order may be a trailing stop-loss order. Accordingly, a portion of any benefit derived from an increase in price may be retained without further actions by the purchaser.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

While particular step orders are described herein, it is understood that other orders of steps are contemplated and that one or more embodiments of the invention may include a variation on the illustrated steps.

Further, the illustrated buy/confirming signals are representative of signals found to be particularly effective. Other signals are contemplated. For example, while the buy signal 250 of FIG. 2 crosses in a lower region 230, such may occur between the lower and upper regions 230 and 240 or may occur in the upper region 240. More, while the confirming signal 310 of FIG. 3 is defined by crossing the threshold 330 representing the −25 mark, such may be indicated by crossing a mark higher than the −50 mark (a mark between about −49, −45, −40, −35, −30, −25, −20, −15, and/or −10). More a confirming volume statistic may correlate to a volume other than 200,000, such as but not limited to between about 50,000; 100,000; 150,000; 200,000; 250,000; 300,000, and/or 350,000. Still further, a confirming relative buying activity statistic may correlate to a number other than greater than 40, such as but not limited to greater than about 25, 30, 35, 40, 45, 50, 55, and/or 60.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method of purchasing a financial instrument, comprising the steps of:
selecting a financial instrument;
observing a buy signal on a first oscillator;
observing a confirming buy signal on a second oscillator;
observing a confirming volume statistic;
observing a confirming relative buying statistic; and
purchasing the financial instrument, wherein the purchasing step is contingent on all of the observations.

2. The method of claim 1, wherein the first oscillator is a slow stochastics oscillator.

3. The method of claim 2, wherein the buy signal is a crossover of a fast line crossing up through a slow line.

4. The method of claim 3, wherein the second oscillator is a Williams % R oscillator.

5. The method of claim 4, wherein the confirming indicator is a Williams % R line crossing up through a threshold on a Williams % R oscillator chart.

6. The method of claim 5, wherein the threshold is −25 on the Williams % R oscillator chart.

7. The method of claim 6, wherein the confirming volume statistic correlates to greater than a 199,999 daily volume.

8. The method of claim 7, wherein the confirming relative buying activity statistic correlates to greater than 39.

9. The method of claim 8, wherein the confirming volume statistic is greater than a 199,999 daily volume statistic.

10. The method of claim 9, wherein the confirming relative buying statistic is greater than 39.

11. The method of claim 10, wherein the purchasing step includes the step of placing a stop-loss order.

12. The method of claim 11, wherein the stop-loss order includes a trailing stop-loss.

13. A method of purchasing a financial instrument, comprising the steps of:
selecting a financial instrument;
observing a buy signal on a slow stochastics oscillator;
observing a confirming buy signal on a Williams % R oscillator;
observing a confirming volume statistic;
observing a confirming relative buying statistic; and
purchasing the financial instrument, wherein the purchasing step is contingent on all of the observations.

14. The method of claim 13, wherein the buy signal is a crossover of a fast line crossing up through a slow line.

15. The method of claim 13, wherein the confirming indicator is a Williams % R line crossing up through a threshold on a Williams % R oscillator chart.

16. The method of claim 15, wherein the threshold is −25 on the Williams % R oscillator chart.

17. The method of claim 13, wherein the confirming volume statistic correlates to greater than a 199,999 daily volume.

18. The method of claim 17, wherein the confirming relative buying activity statistic correlates to greater than 39.

19. The method of claim 8, wherein the confirming volume statistic is greater than a 199,999 daily volume statistic.

20. A method of purchasing a financial instrument, comprising the steps of:
selecting a financial instrument;
observing a buy signal on a slow stochastics oscillator, wherein the buy signal is a crossover of a fast line crossing up through a slow line;
observing a confirming buy signal on a Williams % R oscillator, wherein the confirming indicator is a Williams % R line crossing up through a threshold of −25 on a Williams % R oscillator chart;
observing a confirming volume statistic of greater than 199,999 volume;
observing a confirming relative buying statistic of greater than 39 institutional activity; and
purchasing the financial instrument, wherein the purchasing step is contingent on all of the observations and wherein the purchase includes a trailing stop-loss order.
